(19) United States
(12) Patent Application Publication
(10) Pub. No.: US 2019/0179981 A1
(43) Pub. Date: Jun. 13, 2019

(54) STRUCTURAL ANALYSIS SIMULATION METHOD AND INFORMATION PROCESSING APPARATUS

(71) Applicant: FUJITSU LIMITED, Kawasaki-shi (JP)

(72) Inventors: Takanori Negishi, Nagano (JP); Tatsuya Nagai, Osaka (JP); Nobuaki Ikuta, Osaka (JP)

(73) Assignee: FUJITSU LIMITED, Kawasaki-shi (JP)

(21) Appl. No.: 16/204,101

(22) Filed: Nov. 29, 2018

(30) Foreign Application Priority Data
Dec. 8, 2017 (JP) 2017-235656

(51) Int. Cl. G06F 17/50; G06K 9/32

(52) U.S. Cl. CPC G06F 17/5009; G06K 9/3241

(57) ABSTRACT

A processing unit sets a condition for running a structural analysis simulation of an object, in association with first design data corresponding to the object; identifies, when the first design data is updated according to a design change of the object, a corresponding relationship between regions each included in the first design data and second design data, which corresponds to the object modified with the design change, based on coordinate information included in the first design data and coordinate information included in the second design data; and setting, based on the identified corresponding relationship, the condition in association with the second design data and running the structural analysis simulation of the modified object.

### CROSS-REFERENCE TO RELATED APPLICATION

This application is based upon and claims the benefit of priority of the prior Japanese Patent Application No. 2017-235656, filed on Dec. 8, 2017, the entire contents of which are incorporated herein by reference.

### FIELD

The embodiments discussed herein are related to a structural analysis simulation method and an information processing apparatus.

### BACKGROUND

There are known techniques for conducting a structural analysis of a design object using a computer based on design data of the object, to thereby evaluate the performance of the object in terms of strength, vibration, heat, and the like.

When a structural analysis is performed, conditions for a structural analysis simulation (for example, boundary conditions) are set for regions of an object represented by design data. Subsequently, finite elements are created by element division according to the shape of the object and the purpose of the analysis, and then a simulation is run. Results obtained from the simulation are presented on a display device.

Conventionally, conditions for a simulation are set in association with identification numbers assigned, within an object to be analyzed, to individual regions differentiated by shape, such as points, edges, and surfaces. Such identification numbers are hereinafter referred to as “shape IDs”. For example, within the object, a surface is assigned SurfaceID_1, a different surface is assigned SurfaceID_2, an edge is assigned EdgeID_1, and a different edge is assigned EdgeID_2. Then, conditions are set in association with these individual shape IDs. Thus, holding the conditions in association with the individual shape IDs reduces the need of resetting conditions when structural analyses are repeatedly performed on the same object.

See, for example, Japanese Laid-open Patent Publication No. 11-120383.

However, the conventional technique leaves the problem of possibly being accompanied by changes in the shape IDs defined in design data when a design change has caused changes in the shape of the object (for example, when the number of points and/or surfaces has changed). In the case where changes have been made in the shape IDs, unintentional analysis conditions may be set for regions of the object, which is likely to cause a structural analysis to yield erroneous results.

### SUMMARY

According to an aspect, there is provided a non-transitory computer-readable storage medium storing a computer program that causes a computer to execute a process including: setting a condition for running a structural analysis simulation of an object, in association with first design data corresponding to the object; identifying, when the first design data is updated according to a design change of the object, a corresponding relationship between regions each included in the first design data and second design data, which corresponds to the object modified with the design change, based on coordinate information included in the first design data and coordinate information included in the second design data; and setting, based on the corresponding relationship, the condition in association with the second design data and running the structural analysis simulation of the modified object.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of an information processor and structural analysis simulation method according to a first embodiment;

FIG. 2 is a block diagram illustrating an example of hardware of an information processor according to a second embodiment;

FIG. 3 illustrates a block diagram illustrating an example of functions provided in the information processor;

FIG. 4 is a flowchart illustrating an example of a process carried out by the information processor;

FIG. 5 illustrates a setting example of analysis conditions;

FIG. 6 is a flowchart illustrating an example of a process of identifying a corresponding relationship between regions each included in pre-update and post-update design datasets and a process of setting each analysis condition in association with the post-update design dataset;

FIG. 7 illustrates an example in which a plurality of edges that matches an edge with an analysis condition set is included in the post-update design dataset;

FIG. 8 illustrates an example of Method 2 for tentatively determining a matching edge or edges;

FIG. 9 illustrates an example of Method 2 for tentatively determining a matching surface or surfaces; and

FIG. 10 illustrates an example of Method 2 for tentatively determining a matching solid or solids.

### DESCRIPTION OF EMBODIMENTS

Several embodiments will be described below with reference to the accompanying drawings, wherein like reference numerals refer to like elements throughout.

### (a) First Embodiment

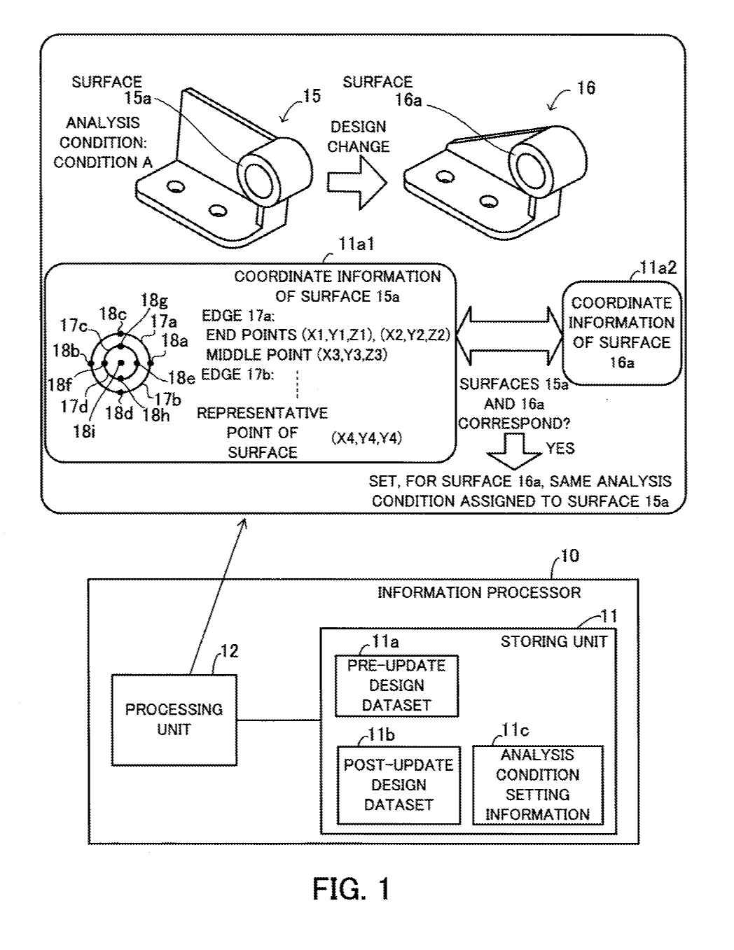

FIG. 1 illustrates an example of an information processor and structural analysis simulation method according to a first embodiment.

An information processor 10 of the first embodiment runs a structural analysis simulation of an object based on a design dataset of the object. Note that the information processor 10 may be a client computer or server computer.

The information processor 10 includes a storing unit 11 and a processing unit 12.

The storing unit 11 may be a volatile memory device such as random access memory (RAM), or a non-volatile memory device such as a hard disk drive (HDD) or flash memory.

The storing unit 11 stores therein design datasets 11a and 11b and analysis condition setting information 11c.

The design datasets 11a and 11b are pre-update and post-update design datasets associated with a design change of an object. Specifically, the design dataset 11a is the pre-update design dataset and the design dataset 11b is the post-update design dataset. The design datasets 11a and 11b may be individually generated based on inputs provided by the user when the information processor 10 implements software for creating a design dataset and allows the user to provide the inputs. Alternatively, the design datasets 11a and 11b may be acquired, for example, from an apparatus external to the information processor 10 via a network.

The analysis condition setting information 11c is information on conditions for conducting a structural analysis (hereinafter referred to as “analysis conditions”), set by the processing unit 12 in association with the individual design datasets 11a and 11b. Examples of such analysis conditions include boundary conditions and conditions for materials of regions included in the object. Examples of the boundary conditions include conditions on in which direction a given region within the object is fixed and in which direction it is free to move (constraint conditions) and conditions on a given region within the object experiences forces in which direction and with what magnitude (loading conditions).

The processing unit 12 is a processor, such as a central processing unit (CPU) and a digital signal processor (DSP). Note however that the processing unit 12 may include an electronic circuit designed for specific use, for example, an application specific integrated circuit (ASIC) or a field programmable gate array (FPGA). The processor executes programs stored in a memory device such as RAM. For example, the processor executes a structural analysis simulation program. The term “multiprocessor”, or simply “processor”, is sometimes used here to refer to a set of multiple processors.

The processing unit 12 sets analysis conditions to be used in a structural analysis simulation of an object, in association with the design dataset 11a corresponding to the object. For example, in setting the analysis conditions, a three-dimensional (3D) image of the object is presented on a screen of a display device (not illustrated) connected to the information processor 10. Then, the processing unit 12 receives an analysis condition specified by the user for each desired region (which is not only a surface or solid but also a point or edge in the following description) within the object, and sets the analysis condition in association with coordinate information representing the region, included in the design dataset 11a. Information obtained in this manner is stored in the storing unit 11 to form the analysis condition setting information 11c.

When the design dataset 11a is updated according to a change in the design of the object, the processing unit 12 identifies a corresponding relationship between regions each included in the pre-update and post-update design datasets 11a and 11b, based on coordinate information included in the pre-update design dataset 11a and coordinate information included in the post-update design dataset 11b. Then, based on the identified corresponding relationship, the processing unit 12 sets the above-mentioned analysis condition in association with the post-update design dataset 11b, and runs a structural analysis simulation of the object modified by the design change. The processing unit 12 may cause the display device (not illustrated) to present results of the structural analysis simulation on its screen.

FIG. 1 depicts an example of a structural analysis simulation method employed by the information processor 10 of the first embodiment.

For a surface 15a, which is a single region within an object 15, a condition A is set as an analysis condition. Assume that due to a design change made to the object 15, an object 16 with an illustrated shape is formed. Since the modified object 16 includes regions having the same configurations as those of the object 15 before the design change, it is preferable that individual analysis conditions set for the regions having the same configurations be carried over. For example, the surface 15a of the pre-change object 15 has the same configuration as a surface 16a of the post-change object 16. The processing unit 12 then identifies a corresponding relationship between these regions (i.e., the surfaces 15a and 16a) based on coordinate information included in the individual pre-update and post-update design datasets 11a and 11b.

For example, coordinate information 11a1 representing the surface 15a, included in the design dataset 11a, includes coordinate information representing edges 17a, 17b, 17c, and 17d and coordinate information representing a representative point of the surface 15a.

The coordinate information representing the edge 17a includes, for example, coordinate information representing end points 18a and 18b of the edge 17a and coordinate information representing a middle point 18c of the edge 17a. The coordinate information representing the edge 17b includes, for example, coordinate information representing the end points 18a and 18b of the edge 17b and coordinate information representing a middle point 18d of the edge 17b. The coordinate information representing the edge 17c includes, for example, coordinate information representing end points 18e and 18f of the edge 17c and coordinate information representing a middle point 18g of the edge 17c. The coordinate information representing the edge 17d includes, for example, coordinate information representing the end points 18e and 18f of the edge 17d and coordinate information representing a middle point 18h of the edge 17d.

A representative point 18i may lie apart from the surface 15a. In the example of FIG. 1, the representative point 18i of the ring-shaped surface 15a is the center point of a circle formed by the edges 17a and 17b.

The processing unit 12 searches the post-update design dataset 11b for a region with coordinate information corresponding to the coordinate information 11a1 representing the above-described surface 15a. For example, the processing unit 12 determines, as the region with coordinate information corresponding to the coordinate information 11a1 of the surface 15a, a region with coordinate information that exactly matches all the coordinate information representing the edges 17a to 17d and the representative point 18i.

Suppose, for example, that the processing unit has detected, in the design dataset 11b, coordinate information 11a2 that exactly matches the coordinate information 11a1. That is, the processing unit 12 has identified the surface 16a, which corresponds to the surface 15a on the pre-change object 15. In this case, the processing unit 12 sets, in the design dataset 11b, the same analysis condition assigned to the surface 15a (that is, the condition A) for the surface 16a. Information on the analysis condition set in the design dataset 11b is recorded, for example, in the storing unit 11. At this time, the processing unit 12 may update the analysis condition setting information 11c, or leave the analysis condition setting information 11c corresponding to the pre-update design dataset 11a.

Note that the processing unit 12 may tentatively determine the surface 16a as a region corresponding to the surface 15a even if the coordinate information 11a1 and the coordinate information 11a2 do not match exactly. In that case, the processing unit 12 may cause the display device (not illustrated) to present, on its screen, a note indicating that the surface 16a is a tentatively determined region, to thereby prompt the user to select whether to allow the analysis condition assigned to the surface 15a to be carried over to the surface 16a.

As described above, the information processor 10 of the first embodiment sets each analysis condition in association with the post-update design dataset 11b based on a corresponding relationship between regions each included in the pre-update and post-update design datasets 11a and 11b, identified from coordinate information included in the individual design datasets 11a and 11b. This prevents unintentional analysis conditions from being set in association with the post-update design dataset 11b, which could occur, for example, in associating each analysis condition with a shape ID, thus being able to avoid a structural analysis from yielding erroneous results. In addition, this technique reduces the need of resetting analysis conditions for the post-update design dataset 11b in a reanalysis after a design change.

Other than a design change, there are various causes for changes in shape IDs, such as a user operation on design data generation software (for example, an operation of editing design datasets of a plurality of objects at the same time). Even if changes are made in shape IDs due to such a cause, incorrect setting of analysis conditions is prevented because the information processor 10 sets each analysis condition in association with the post-update design dataset 11b based on a corresponding relationship between regions each included in the pre-update and post-update design datasets 11a and 11b, identified from coordinate information included in the individual design datasets 11a and 11b.

The information processor 10 also eliminates the need of holding shape IDs, which in turn eliminates the need of allocating memory space for the shape IDs.

### (b) Second Embodiment

This part explains a second embodiment.

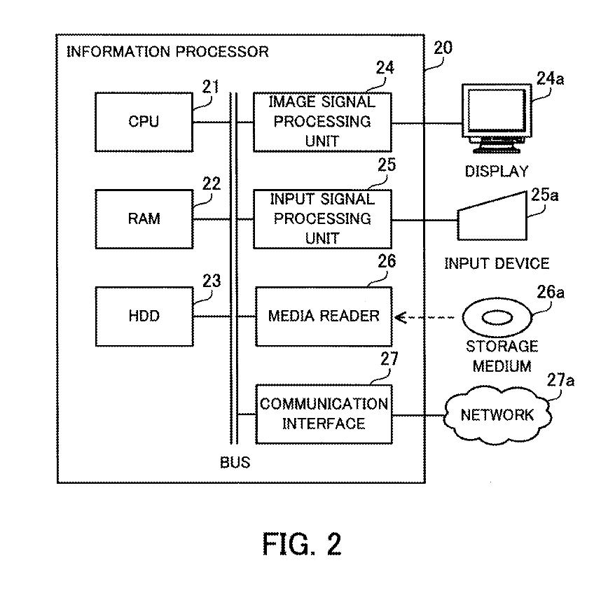

FIG. 2 is a block diagram illustrating an example of hardware of an information processor.

An information processor 20 includes a CPU 21, a RAM 22, a HDD 23, an image signal processing unit 24, an input signal processing unit 25, a media reader 26, and a communication interface 27. These individual units are connected to a bus.

The CPU 21 is a processor including a computing circuit for carrying out program instructions. The CPU 21 reads out at least part of programs and data stored in the HDD 23, loads them into the RAM 22, and executes the loaded programs. Note that the CPU 21 may include two or more processor cores and the information processor 20 may include two or more processors, and processes to be described later may be executed in parallel using these processors or processor cores. The term “processor” may be used to refer to a set of processors (multiprocessor).

The RAM 22 is volatile semiconductor memory for temporarily storing therein programs to be executed by the CPU 21 and data to be used by the CPU 21 for its computation. Note that the information processor 20 may be provided with a different type of memory other than RAM, or may be provided with two or more memory devices.

The HDD 23 is a non-volatile memory device to store therein software programs, such as an operating system (OS), middleware, and application software, as well as various types of data. The programs include, for example, a structural analysis simulation program for causing the information processor 20 to run a structural analysis simulation. Note that the information processor 20 may be provided with a different type of memory device, such as flash memory or a solid state drive (SSD), or may be provided with two or more non-volatile memory devices.

The image signal processing unit 24 produces video images in accordance with drawing commands from the CPU 21 and displays them on a screen of a display 24a coupled to the information processor 20. The display 24a may be any type of display, such as a cathode ray tube (CRT) display; a liquid crystal display (LCD); a plasma display panel (PDP); or an organic electro-luminescence (OEL) display.

The input signal processing unit 25 receives an input signal from an input device 25a connected to the information processor 20 and supplies the input signal to the CPU 21. Various types of input devices may be used as the input device 25a, for example, a pointing device, such as a mouse, a touch panel, a touch-pad, or a trackball; a keyboard; a remote controller; or a button switch. A plurality of types of input devices may be connected to the information processor 20.

The media reader 26 is a reader for reading programs and data recorded in a storage medium 26a. As the storage medium 26a, any of the following may be used: a magnetic disk, an optical disk, a magneto-optical disk (MO), and a semiconductor memory. Examples of the magnetic disk are a flexible disk (FD) and a HDD. Examples of the optical disk are a compact disc (CD) and a digital versatile disc (DVD).

The media reader 26 copies programs and data read from the storage medium 26a to a different storage medium, for example, the RAM 22 or the HDD 23. The read programs are executed, for example, by the CPU 21. Note that the storage medium 26a may be a portable storage medium, and may be used to distribute the programs and data. The storage medium 26a and the HDD 23 are sometimes referred to as computer-readable storage media.

The communication interface 27 is connected to a network 27a and communicates with different information processors via the network 27a. The communication interface 27 may be a wired communication interface connected via a cable to a communication device, such as a switch, or may be a wireless communication interface connected via a wireless link to a base station.

The information processor 20 described above may be a client computer or server computer.

Next described are functions of the information processor 20 and its processing procedure.

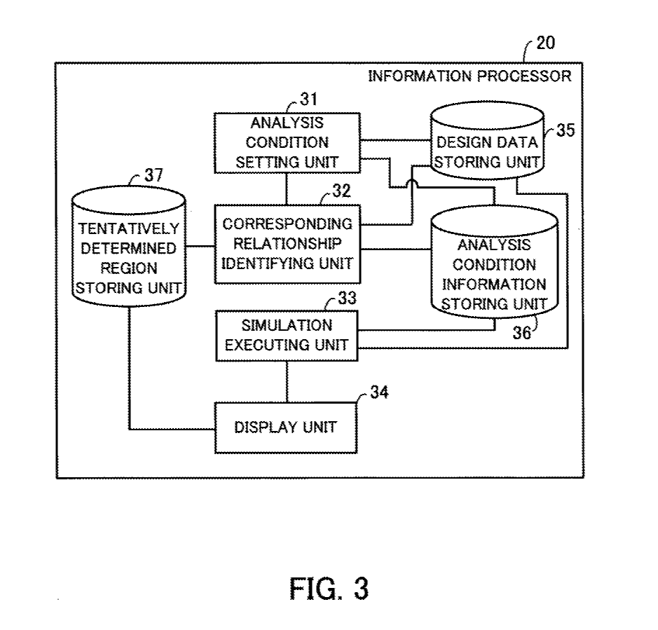

FIG. 3 illustrates a block diagram illustrating an example of functions provided in an information processor.

The information processor 20 includes an analysis condition setting unit 31, a corresponding relationship identifying unit 32, a simulation executing unit 33, a display unit 34, a design data storing unit 35, an analysis condition information storing unit 36, and a tentatively determined region storing unit 37. The analysis condition setting unit 31, the corresponding relationship identifying unit 32, the simulation executing unit 33, and the display unit 34 are implemented, for example, as modules of a program executed by the CPU 21. The design data storing unit 35, the analysis condition information storing unit 36, and the tentatively determined region storing unit 37 are implemented using a storage area secured, for example, in the RAM 22 or the HDD 23.

The analysis condition setting unit 31 sets each analysis condition in association with a design dataset of an object for a structural analysis. The analysis condition setting unit 31 also sets, based on a corresponding relationship between regions each included in pre-update and post-update design datasets, identified by the corresponding relationship identifying unit 32, the analysis condition in the post-update design dataset.

When a design dataset of the object is updated according to a design change of the object, the corresponding relationship identifying unit 32 identifies, based on coordinate information included in the individual pre-update and post-update design datasets, a corresponding relationship between regions each included in the pre-update and post update design datasets.

The simulation executing unit 33 runs a structural analysis simulation of the object modified by the design change.

The display unit 34 controls the image signal processing unit 24 to present results of the structural analysis simulation on a screen of the display 24a. In addition, the display unit 34 causes information about each region tentatively determined in a process described below to be presented on the screen of the display 24a.

The design data storing unit 35 stores therein the pre-update and post-update design datasets associated with the design change of the object.

The analysis condition information storing unit stores therein information about analysis conditions set in association with each design dataset.

The tentatively determined region storing unit stores therein information about each region tentatively determined in a process described below.

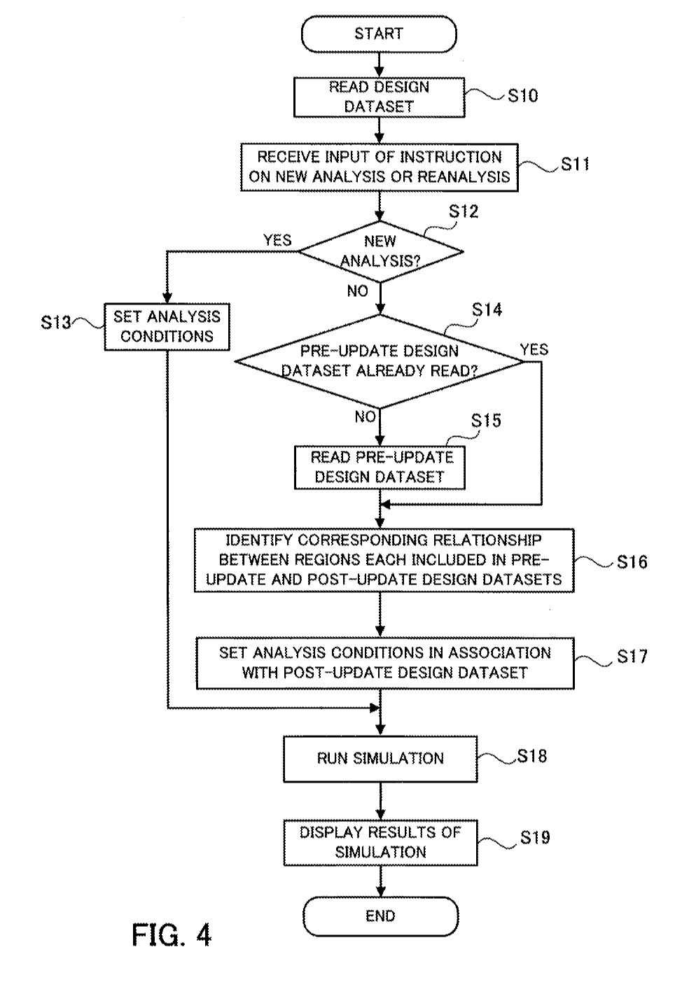

FIG. 4 is a flowchart illustrating an example of a process carried out by an information processor.

(Step S10) The analysis condition setting unit 31 reads a design dataset stored, for example, in the HDD 23.

(Step S11) The analysis condition setting unit 31 receives an input of an instruction signal indicating whether to conduct a new analysis or reanalysis of the structure of an object which corresponds to the read design dataset. The instruction signal is input by the user using the input device 25a.

(Step S12) The analysis condition setting unit 31 judges whether a new analysis is to be conducted, based on the input instruction signal. The process moves to step S13 if a new analysis is to be conducted, and moves to step S14 if a reanalysis is to be conducted.

(Step S13) When a new analysis is to be conducted, the analysis condition setting unit 31 sets analysis conditions in association with the design dataset of an object for a structural analysis. For example, the analysis condition setting unit 31 controls the image signal processing unit 24 to display a 3D image of the object on the screen of the display 24a. Then, the analysis condition setting unit 31 receives, via the input signal processing unit 25, analysis conditions individually specified by the user using the input device 25a for desired regions (each of which is not only a surface or solid but also a point or edge in the following description) within the object. Subsequently, the analysis condition setting unit 31 sets each of the analysis conditions in association with coordinate information of its corresponding region, included in the design dataset.

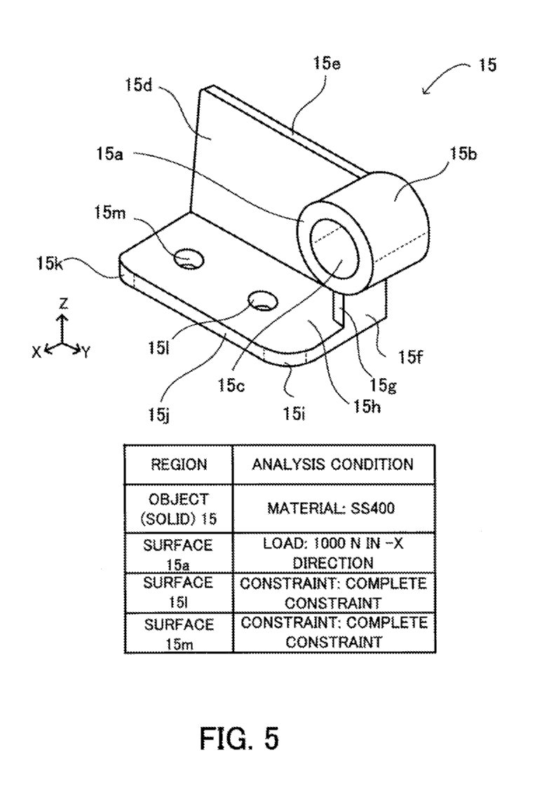

FIG. 5 illustrates a setting example of analysis conditions.

The object 15 of FIG. 5 is the same as one illustrated in FIG. 1. The object 15 has a plurality of surfaces including surfaces 15a, 15b, 15c, 15d, 15e, 15f, 15g, 15h, 15i, 15j, 15k, 151, and 15m. For example, on a 3D image of the object 15 displayed on the screen, the user specifies, using the input device 25a, each region for which an analysis condition is to be set and details of the analysis condition according to the type of a structural analysis to be conducted.

In the example of FIG. 5, an analysis condition that the solid object 15 is made of SS400 (a type of steel) is set. In addition, an analysis condition that a uniformly distributed load of 1000N is applied in the −x direction is set for the surface 15a. Further, an analysis condition of complete constraint (i.e., being locked in all directions) is set for the surfaces 151 and 15m.

The analysis condition setting unit 31 stores, in the analysis condition information storing unit 36, information on the analysis conditions set in the above-described manner.

After step S13, the process moves to step S18.

(Step S14) On the other hand, when a reanalysis is to be conducted, the corresponding relationship identifying unit 32 judges whether a design dataset corresponding to a pre-change object (a pre-update design dataset) has already been read, for example, from the HDD 23. The process moves to step S15 if it has yet to be read, and moves to step S16 if it has already been read.

(Step S15) The corresponding relationship identifying unit 32 reads the pre-update design dataset, for example, from the HDD 23. At this time, the corresponding relationship identifying unit 32 may cause the display 24a to present a screen for selection of a pre-update design dataset and then read a selected design dataset from the HDD 23.

(Step S16) The corresponding relationship identifying unit 32 identifies a corresponding relationship between regions each included in the pre-update and post-update design datasets, based on coordinate information included in the individual pre-update and post-update design datasets.

(Step S17) Based on each of the identified corresponding relationships, the analysis condition setting unit 31 sets an analysis condition in association with the post-update design dataset.

An example of processing in steps S16 and S17 above is described later.

(Step S18) The simulation executing unit 33 runs a structural analysis simulation of the object based on the design dataset and the analysis conditions set in association with the design dataset.

(Step S19) The display unit 34 controls the image signal processing unit 24 to present results of the structural analysis simulation on the screen of the display 24a.

Next described is an example of the process of identifying a corresponding relationship between regions each included in the pre-update and post-update design datasets and the process of setting each analysis condition in association with the post-update design dataset.

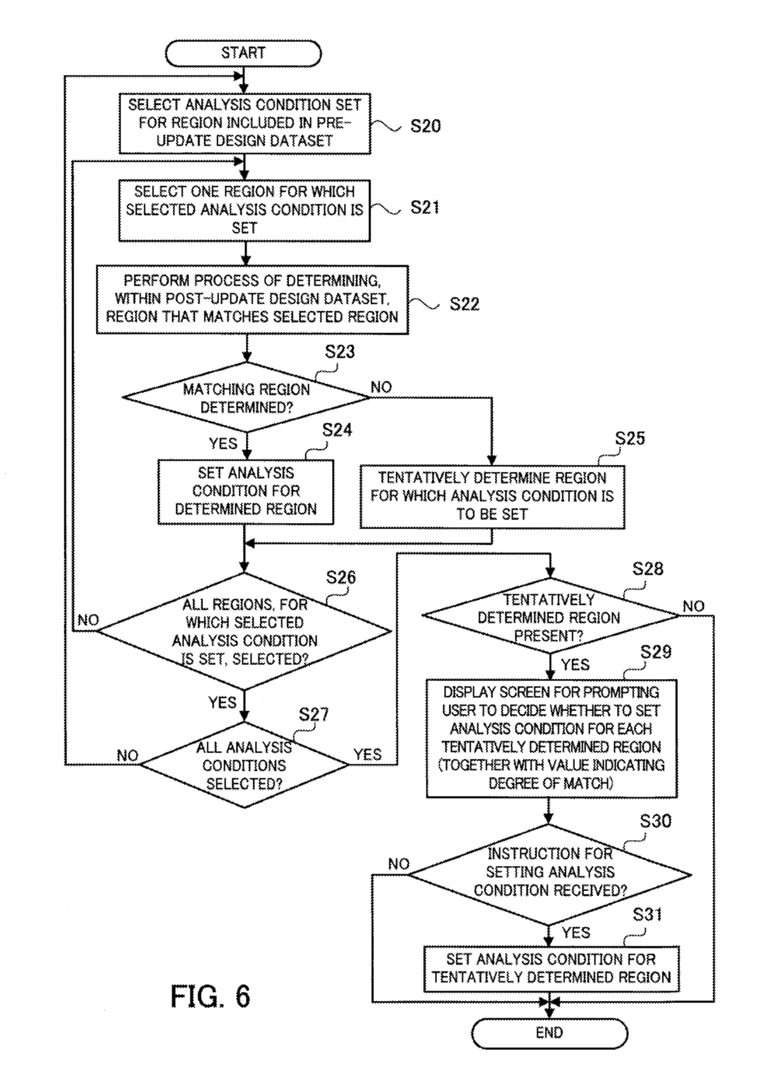

FIG. 6 is a flowchart illustrating an example of a process of identifying a corresponding relationship between regions each included in the pre-update and post-update design datasets and a process of setting each analysis condition in association with the post-update design dataset.

(Step S20) The corresponding relationship identifying unit 32 selects one analysis condition set for regions included in the pre-update design dataset. For example, as depicted in FIG. 5, conditions each regarding the material, load, or constraint are set for regions included in the design dataset of the object 15 as analysis conditions. The corresponding relationship identifying unit 32 selects one of the analysis conditions.

(Step S21) Next, the corresponding relationship identifying unit 32 selects one region for which the selected analysis condition is set. Assuming that the analysis condition of “CONSTRAINT: COMPLETE CONSTRAINT” is selected in step S20 amongst the analysis conditions depicted in FIG. 5, there are two regions for which the analysis condition is set, i.e., the surfaces 151 and 15m. In this case, the corresponding relationship identifying unit 32 selects one of them.

(Step S22) The corresponding relationship identifying unit 32 performs a process of determining, within the post-update design dataset, a region that matches the selected region.

Next described are examples of the determining process. Note that each region for which an analysis condition is set is not only a surface or solid but also a point or edge.

(Match Determination Process for Points)

In the case where a point for which an analysis condition is set is included in the pre-update design dataset, the corresponding relationship identifying unit determines, within the post-update design dataset, a point whose coordinate information matches that of the point included in the pre-update design dataset.

In some cases, a plurality of points having the same coordinate information is included in a single design dataset. This situation occurs, for example, when a point on a contact surface of two objects is defined for each of the objects. In that case, the corresponding relationship identifying unit 32 identifies a solid whose coordinate information matches that of a solid including the point with the analysis condition set, and determines a point included in the identified solid as a point that matches the point with the analysis condition set. If there is no solid including the point with the analysis condition set, the corresponding relationship identifying unit 32 identifies, within the post-update design dataset, a surface (or edge) whose coordinate information matches that of a surface (or edge if there is no surface) including the point with the analysis condition set, and determines a point included in the identified surface (or edge) as a point that matches the point with the analysis condition set. If, in this procedure, no matching solid, surface, or edge is found, no matching point is determined (“undetermined”). Note that match determination processes for solids, surfaces, and edges are described below.

In the case where the pre-update and post-update design datasets individually represent models each consisting of a single point, the corresponding relationship identifying unit 32 determines the point of the post-update design dataset as a point that matches the point with the analysis condition set, instead of performing the above-described match determination procedure using coordinate information.

(Match Determination Process for Edges)

In the case where an edge for which an analysis condition is set is included in the pre-update design dataset, the corresponding relationship identifying unit 32 determines, within the post-update design dataset, an edge having end and middle points whose coordinate information matches that of end and middle points (the number of middle points is optional) of the edge with the analysis condition set.

As for determining, within the post-update design dataset, an edge that matches the edge with the analysis condition set, a match on the type of an edge (straight line, arc, spline, or the like) and a match on the length of the edge may be added as determining conditions. The type of an edge is determined by information on the edge, included in a corresponding design dataset. This is because the information on an edge being an arc of a circle includes an entry on the radius, and the information on an edge being a spline includes an entry on control points.

As is the case in points, a plurality of edges having the same coordinate information is included in a single design dataset in some cases. This situation occurs, for example, when an edge on a contact surface of two objects is defined for each of these objects. In that case, the corresponding relationship identifying unit 32 identifies a solid whose coordinate information matches that of a solid including the edge with the analysis condition set, and determines an edge included in the identified solid as an edge that matches the edge with the analysis condition set.

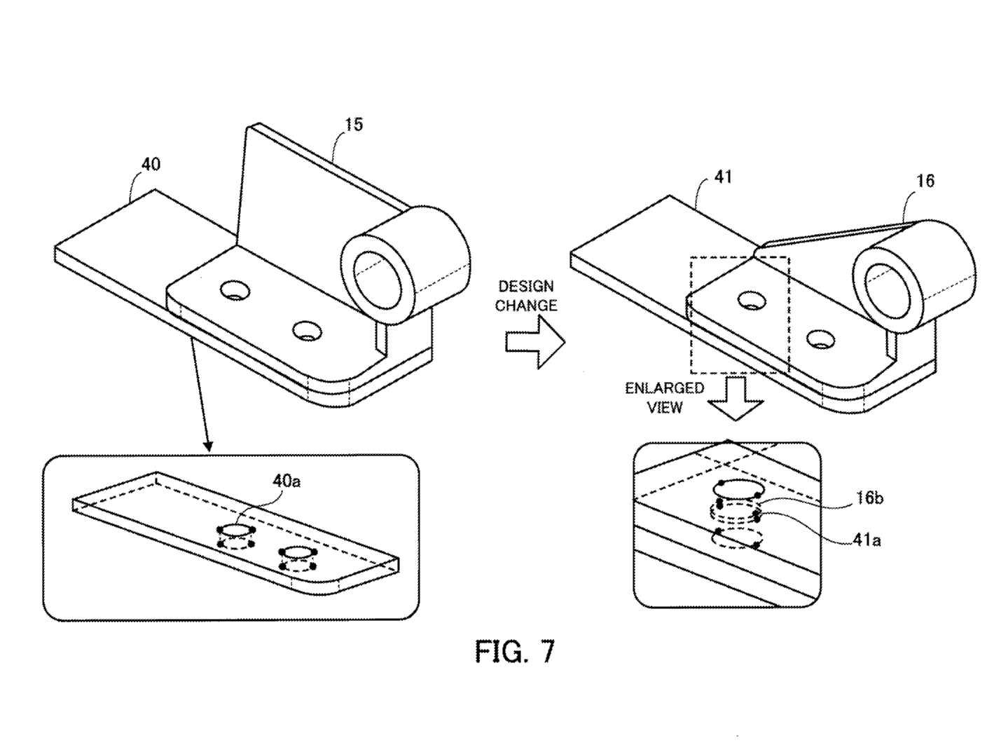

FIG. 7 illustrates an example in which a plurality of edges that matches an edge with an analysis condition set is included in a post-update design dataset.

Assume in an object 40 that, for example, an analysis condition is set for an edge 40a on the contact surface between the objects 40 and 15. In such a case, in objects 16 and 41 modified by a design change, two edges, that is, an edge 16b included in the object 16 and an edge 41a included in the object 41, may be detected as edges that match the edge 40a of the object 40. FIG. 7 depicts, for convenience, the edges 16b and 41a separated from each other; however, in reality, these edges 16b and 41a exactly coincide with each other.

Hence, the corresponding relationship identifying unit 32 searches the post-update design dataset for a solid whose coordinate information matches that of a solid including the edge 40a, i.e., the object 40. If the object 41 is determined as a solid whose coordinate information matches that of the object 40, the corresponding relationship identifying unit 32 determines the edge 41a belonging to the object 41 as an edge that matches the edge 40a.

Note that, if there is no solid including the edge with the analysis condition set, the corresponding relationship identifying unit 32 identifies, within the post-update design dataset, a surface whose coordinate information matches that of a surface including the edge with the analysis condition set, and determines an edge included in the identified surface as an edge that matches the edge with the analysis condition set. If, in this procedure, no matching solid or surface is found, no matching edge is determined (“undetermined”). Note that match determination processes for solids and surfaces are described below.

In the case where the pre-update and post-update design datasets individually represent models each consisting of a single edge, the corresponding relationship identifying unit 32 determines the edge of the post-update design dataset as an edge that matches the edge with the analysis condition set, instead of performing the above-described match determination procedure using coordinate information.

(Match Determination Process for Surfaces)

In the case where a surface for which an analysis condition is set is included in the pre-update design dataset, the corresponding relationship identifying unit 32 determines, within the post-update design dataset, a surface having edges whose coordinate information matches that of all edges on the surface with the analysis condition set and representative points whose coordinate information matches that of all representative points (the number of representative points is optional) on the surface with the analysis condition set. A procedure for match determination for edges here follows the above-described match determination process for edges, and a procedure for match determination for representative points here follows the above-described match determination process for points.

As for determining, within the post-update design dataset, a surface that matches the surface with the analysis condition set, a match on the type of a surface (flat, cylindrical, conical, or the like) and a match on the surface area may be added as determining conditions. The type of a surface is determined by information on the surface, included in a corresponding design dataset.

As is the case in points and edges, a plurality of surfaces having the same coordinate information is included in a single design dataset in some cases. This situation occurs, for example, when a contact surface of two objects is defined for each of these objects. In that case, the corresponding relationship identifying unit 32 identifies, within the post-update design dataset, a solid whose coordinate information matches that of a solid including the surface with the analysis condition set, and determines a surface included in the identified solid as a surface that matches the surface with the analysis condition set. If, in this procedure, no matching solid is found, no matching surface is determined (“undetermined”). Note that a matching determination process for solids is described below.

In the case where the pre-update and post-update design datasets individually represent models each consisting of a single surface, the corresponding relationship identifying unit 32 determines the surface of the post-update design dataset as a surface that matches the surface with the analysis condition set, instead of performing the above-described match determination procedure using coordinate information.

(Match Determination Process for Solids)

In the case where a solid for which an analysis condition is set is included in the pre-update design dataset, the corresponding relationship identifying unit determines, within the post-update design dataset, a solid having surfaces whose coordinate information matches that of all surfaces on the solid with the analysis condition set. A procedure for match determination for surfaces here follows the above-described match determination process for surfaces.

As for determining, within the post-update design dataset, a solid that matches the solid with the analysis condition set, a match on the type of a solid (a rectangular parallelepiped, cube, cylinder, or the like), a match on the solid volume, a match on the solid's center of gravity, and a match on points within each solid may be added as determining conditions. The type of a solid is determined by information on the solid included in a corresponding design dataset.

If a plurality of solids that match the solid with the analysis condition set is found in the post-update design dataset, no matching solid is determined (“undetermined”).

In the case where the pre-update and post-update design datasets individually represent models each consisting of a single solid, the corresponding relationship identifying unit 32 determines the solid of the post-update design dataset as a solid that matches the solid with the analysis condition set, instead of performing the above-described match determination procedure using coordinate information.

(Step S23) The corresponding relationship identifying unit 32 judges whether, within the post-update design dataset, a region that matches the region with the analysis condition set has been determined by the above-described process. The process moves to step S24 if, within the post-update design dataset, a region that matches the region with the analysis condition set has been determined, and moves to step S25 if not.

(Step S24) The analysis condition setting unit sets the analysis condition for the matching region included in the post-update design data, determined by the corresponding relationship identifying unit 32.

(Step S25) When having failed to determine, within the post-update design dataset, a region that matches the region with the analysis condition set, the corresponding relationship identifying unit 32 tentatively determines, within the post-update design dataset, a region for which the analysis condition is to be set. Next described are examples of the tentative determination process.

Based on coordinate information, the corresponding relationship identifying unit 32 identifies, within the post-update design dataset, a region similar to the region with the analysis condition set, included in the pre-update design dataset, and tentatively determines the identified region as a region for which the analysis condition is to be set. Note that the similar region identified by the corresponding relationship identifying unit 32 is, for example, regions sharing common elements. The corresponding relationship identifying unit 32 performs, for example, the following process according to the shape of the region.

(Tentative Match Determination Process for Points)

When, in step S22, no point that matches the point with the analysis condition set is determined in the post-update design dataset, the corresponding relationship identifying unit 32 extracts, from the post-update design dataset, a point represented by coordinate information closest to that of the point with the analysis condition set. Then, the corresponding relationship identifying unit 32 tentatively determines the extracted point as a point for which the analysis condition is to be set. The corresponding relationship identifying unit 32 may calculate a value indicating the degree of match according to the distance between the point with the analysis condition set and the tentatively determined point. The corresponding relationship identifying unit 32 may designate, as tentatively determined targets, a plurality of points each associated with a value indicating a different degree of match.

(Tentative Match Determination Process for Edges)

When, in step S22, no edge that matches the edge with the analysis condition set is determined in the post-update design dataset, the corresponding relationship identifying unit 32 tentatively determines an edge for which the analysis condition is to be set, for example, using one of the following three methods.

(Method 1) The corresponding relationship identifying unit 32 designates, as a tentatively determined target, an edge having the highest number of points whose coordinate information individually matches that of each point (end or middle point) of the edge with the analysis condition set. At this time, the corresponding relationship identifying unit 32 may use a tentatively determined point corresponding to each point of the edge with the analysis condition set. This scheme is adopted in order to prevent a lot of edges from failing to be tentatively determined. The scheme may also be adopted by Method 2 described below.

(Method 2) Assume that the post-update design dataset includes a plurality of edges having points whose coordinate information matches that of each point of the edge with the analysis condition set. Assume also that the plurality of edges includes not only these points whose coordinate information matches that of each point of the edge with the analysis condition set, but also other points with matching coordinate information. Further assume that the total length of a group formed of the plurality of edges (i.e., the sum of the length of the edges) coincides with the length of the edge with the analysis condition set. In this case, the corresponding relationship identifying unit 32 tentatively determines this group as an edge that matches the edge with the analysis condition set.

There may be no group consisting of a plurality of edges, whose total length exactly coincides with the length of the edge with the analysis condition set. In that case, the corresponding relationship identifying unit 32 may select, as a tentatively determined target, a group with total length which most closely matches the length of the edge with the analysis condition set.

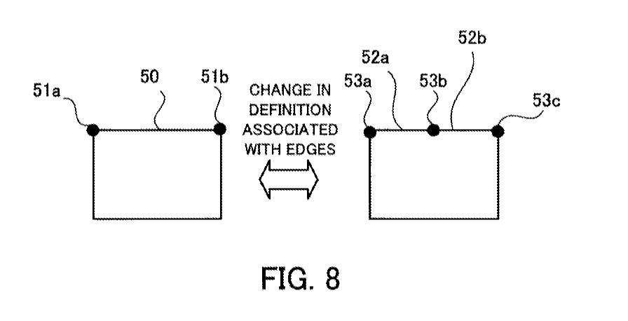

FIG. 8 illustrates an example of Method 2 for tentatively determining a matching edge or edges.

Assume that, in FIG. 8, an edge 50 with end points 51a and 51b is defined in a pre-update design dataset. However, a design change of a corresponding object causes a change in the definition of the edge 50, and two edges 52a and 52b are defined in a post-update design dataset, in place of the edge 50. If an analysis condition has been set for the edge 50, the corresponding relationship identifying unit 32 performs a procedure described next.

If having detected the edge 52a having an end point 53a whose coordinate information matches that of the end point 51a and the edge 52b having an end point 53c whose coordinate information matches that of the end point 51b, the corresponding relationship identifying unit 32 judges whether the other end points of the individual edges 52a and 52b have the same coordinate information. In the example of FIG. 8, an end point 53b is shared by the edges 52a and 52b, and it thus turns out that the other end points of the two edges 52a and 52b match each other. In this case, the corresponding relationship identifying unit 32 calculates the sum of the length of the edges 52a and 52b. If the calculated sum of the length matches the length of the edge 50, then the corresponding relationship identifying unit 32 tentatively determines a group consisting of the edges 52a and 52b as an edge for which the analysis condition is to be set.

Thus, this procedure provides an opportunity of setting an analysis condition (to be described later) to the group described above even if a design change of a corresponding object has caused a change in the definition of an edge.

If, by Method 2 above, the total length of the group is different from the length of the edge with the analysis condition set, the corresponding relationship identifying unit 32 designates the edge obtained by Method 1 as a tentatively determined target. On the other hand, if, by Method 2, the total length of the group coincides with the length of the edge with the analysis condition set, the corresponding relationship identifying unit 32 does not use the edge obtained by Method 1 and designates the group obtained by Method 2 as a tentatively determined target instead.

If a design change of a corresponding object causes a change in the definition associated with edges in such a manner that a plurality of edges, for each of which an analysis condition is set, is changed to a single edge (that is, the change here is caused in an inverse manner to the change described above), the corresponding relationship identifying unit 32 may designate, with respect to each of the plurality of edges, the common single edge as a tentatively determined target.

Assume that, for example, the post-update design dataset includes a single edge having points whose coordinate information matches that of individual points included in each of a plurality of edges for which the same analysis condition is set. Assume also that the plurality of edges includes not only these points whose coordinate information matches that of each point of the edge included in the post-update design dataset, but also other points with matching coordinate information. Further, assume that the total length of a group formed of the plurality of edges (i.e., the sum of the length of the edges) each with the analysis condition set coincides with the length of the single edge included in the post-update design dataset. In this case, the corresponding relationship identifying unit 32 tentatively determines the single edge in the post-update design dataset as an edge that matches the plurality of edges with the analysis condition set. This procedure is carried out, for example, when the edges 52a and 52b of FIG. 8 are edges with the analysis condition set and the edge 50 is an edge included in the post-update design dataset.

(Method 3) If no edge having points whose coordinate information individually matches that of each point (end or middle point) of the edge with the analysis condition set is found in the post-update design dataset, the corresponding relationship identifying unit 32 executes, for example, the following procedure based on the type of the edge with the analysis condition set.

When the edge with the analysis condition set is a straight line, the corresponding relationship identifying unit 32 selects, amongst edges included in the post-update design dataset, an edge parallel and closest in distance to the edge with the analysis condition set as a tentatively determined target.

When the edge with the analysis condition set is not a straight line, the corresponding relationship identifying unit 32 selects a tentatively determined target, for example, in the following manner. The corresponding relationship identifying unit 32 identifies, amongst edges included in the post-update design dataset, edges whose type and length coincide with the edge with the analysis condition set and which are located parallel to the edge with the analysis condition set. Then, the corresponding relationship identifying unit 32 designates, amongst the identified edges, an edge closest in distance to the edge with the analysis condition set as the tentatively determined target. Alternatively, the corresponding relationship identifying unit 32 identifies, amongst the edges included in the post-update design dataset, edges whose type coincides with the edge with the analysis condition set and which lie in the same plane as the edge with the analysis condition set, and designates, amongst the identified edges, an edge closest in distance to the edge with the analysis condition set as the tentatively determined target.

The corresponding relationship identifying unit 32 may calculate a value indicating the degree of match between the edge with the analysis condition set and the tentatively determined edge. For example, if the tentatively determined edge has a higher number of points whose coordinate information individually matches that of each point (end or middle point) of the edge with the analysis condition set, the corresponding relationship identifying unit 32 assigns a value indicating a higher degree of match. Alternatively, the corresponding relationship identifying unit 32 may calculate the value indicating the degree of match, for example, based on the ratio between the length of the edge with the analysis condition set and that of the tentatively determined edge (the total length in the case where the tentatively determined edge is formed of a group of edges) or the degree of proximity between the edge with the analysis condition set and the tentatively determined edge. The degree of match is numerically represented, for example, by a value between 0 and 1, with a value closer to 1 indicating a higher degree of match. Further, alternatively, the corresponding relationship identifying unit 32 may calculate a value indicating the degree of match for each of such conditions as mentioned above and multiply the calculated values, and then output the multiplication result as the final index for the degree of match.

Note that the corresponding relationship identifying unit 32 may designate, as tentatively determined targets, a plurality of edges each associated with a value indicating a different degree of match.

(Tentative Match Determination Process for Surfaces)

When, in step S22, no surface that matches the surface with the analysis condition set is determined in the post-update design dataset, the corresponding relationship identifying unit 32 tentatively determines a surface for which the analysis condition is to be set, for example, using one of the following three methods.

(Method 1) The corresponding relationship identifying unit 32 designates, as a tentatively determined target, a surface having the highest number of edges whose coordinate information individually matches that of each edge of the surface with the analysis condition set. At this time, the corresponding relationship identifying unit 32 may use a tentatively determined edge corresponding to each edge of the surface with the analysis condition set. This scheme is adopted in order to prevent a lot of surfaces from failing to be tentatively determined. The scheme may also be adopted by Method 2 described below.

(Method 2) Assume that the post-update design dataset includes a plurality of surfaces each having one or more edges whose coordinate information matches that of one or more of a plurality of edges of the surface with the analysis condition set, and that the plurality of surfaces also includes other edges that share the same coordinate information. Further, assume that the total area of a group formed of the plurality of surfaces coincides with the area of the surface with the analysis condition set. In this case, the corresponding relationship identifying unit 32 tentatively determines this group as a surface that matches the surface with the analysis condition set.

There may be no group consisting of a plurality of surfaces, whose total area exactly coincides with the area of the surface with the analysis condition set. In that case, the corresponding relationship identifying unit 32 may select, as a tentatively determined target, a group with total area which most closely matches the area of the surface with the analysis condition set.

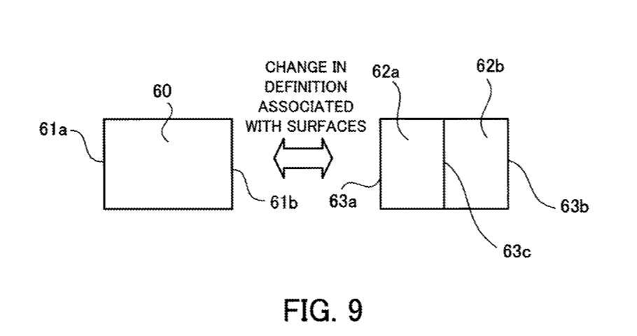

FIG. 9 illustrates an example of Method 2 for tentatively determining a matching surface or surfaces.

Assume that, in FIG. 9, a surface 60 with edges 61a and 61b is defined in a pre-update design dataset. However, a design change of a corresponding object causes a change in the definition of the surface 60, and two surfaces 62a and 62b are defined in a post-update design dataset, in place of the surface 60. If an analysis condition has been set for the surface 60, the corresponding relationship identifying unit 32 performs a procedure described next.

If having detected the surface 62a having an edge 63a whose coordinate information matches that of the edge 61a and the surface 62b having an edge 63b whose coordinate information matches that of the edge 61b, the corresponding relationship identifying unit 32 judges whether different edges of the individual surfaces 62a and 62b share the same coordinate information. In the example of FIG. 9, an edge 63c is shared by the surfaces 62a and 62b, and it thus turns out that the different edges of the two surfaces 62a and 62b match each other. In this case, the corresponding relationship identifying unit 32 calculates the sum of the area of the surfaces 62a and 62b. If the calculated sum of the area matches the area of the surface 60, then the corresponding relationship identifying unit 32 tentatively determines a group consisting of the surfaces 62a and 62b as a surface for which the analysis condition is to be set.

Thus, this procedure provides an opportunity of setting an analysis condition (to be described later) to the group described above even if a design change of a corresponding object has caused a change in the definition of a surface.

If, by Method 2 above, the total area of the group is different from the area of the surface with the analysis condition set, the corresponding relationship identifying unit 32 designates the surface obtained by Method 1 as a tentatively determined target. On the other hand, if, by Method 2, the total area of the group coincides with the area of the surface with the analysis condition set, the corresponding relationship identifying unit 32 does not use the surface obtained by Method 1 and designates the group obtained by Method 2 as a tentatively determined target instead.

If a design change of a corresponding object causes a change in the definition associated with surfaces in such a manner that a plurality of surfaces, for each of which an analysis condition is set, is changed to a single surface (that is, the change here is caused in an inverse manner to the change described above), the corresponding relationship identifying unit 32 may designate, with respect to each of the plurality of surfaces, the common single surface as a tentatively determined target.

Assume that, for example, the post-update design dataset includes a single surface having edges whose coordinate information individually matches that of an edge included in each of a plurality of surfaces for which the same analysis condition is set. Assume also that the plurality of surfaces includes not only these edges whose coordinate information individually matches that of each edge of the surface included in the post-update design dataset, but also other edges with matching coordinate information. Further, assume that the total area of a group formed of the plurality of surfaces (i.e., the sum of the area of the individual surfaces) each with the analysis condition set coincides with the area of the single surface included in the post-update design dataset. In this case, the corresponding relationship identifying unit 32 tentatively determines the single surface in the post-update design dataset as a surface that matches the plurality of surfaces with the analysis condition set. This procedure is carried out, for example, when the surfaces 62a and 62b of FIG. 9 are surfaces with the analysis condition set and the surface 60 is a surface included in the post-update design dataset.

(Method 3) If no surface having edges whose coordinate information individually matches that of each edge of the surface with the analysis condition set is found in the post-update design dataset, the corresponding relationship identifying unit 32 executes, for example, the following procedure based on the type of the surface with the analysis condition set.

When the surface with the analysis condition set is a planar surface, the corresponding relationship identifying unit 32 selects, amongst surfaces included in the post-update design dataset, a surface parallel and closest in distance to the surface with the analysis condition set as a tentatively determined target.

When the surface with the analysis condition set is not a planar surface (i.e., curved surface), the corresponding relationship identifying unit 32 selects a tentatively determined target, for example, in the following manner. The corresponding relationship identifying unit 32 identifies, amongst curved surfaces included in the post-update design dataset, curved surfaces whose type and area coincide with the curved surface with the analysis condition set and which are located parallel to the curved surface with the analysis condition set. Then, the corresponding relationship identifying unit 32 designates, amongst the identified curved surfaces, a curved surface closest in distance to the curved surface with the analysis condition set as the tentatively determined target. Alternatively, the corresponding relationship identifying unit 32 identifies, amongst the curved surfaces included in the post-update design dataset, curved surfaces whose type coincides with the curved surface with the analysis condition set and which are located parallel to the curved surface with the analysis condition set. Then, the corresponding relationship identifying unit 32 designates, amongst the identified curved surfaces, a curved surface closest in distance to the curved surface with the analysis condition set as the tentatively determined target. Further, alternatively, the corresponding relationship identifying unit 32 identifies, amongst the curved surfaces included in the post-update design dataset, curved surfaces whose type coincides with the curved surface with the analysis condition set and which lie in the same curved plane as the curved surface with the analysis condition set. Then, the corresponding relationship identifying unit 32 designates, amongst the identified curved surfaces, a curved surface closest in distance to the curved surface with the analysis condition set as the tentatively determined target. The curved surface closest in distance amongst the curved surfaces lying in the same curved plane as the curved surface with the analysis condition set is, for example, a curved surface having a largest overlap in area with the curved surface with the analysis condition set, or a curved surface having its center of gravity closest to the curved surface with the analysis condition set.

The corresponding relationship identifying unit 32 may calculate a value indicating the degree of match between the surface with the analysis condition set and the tentatively determined surface. For example, if the tentatively determined surface has a higher number of edges whose coordinate information individually matches that of each edge of the surface with the analysis condition set, the corresponding relationship identifying unit 32 assigns a value indicating a higher degree of match. Alternatively, the corresponding relationship identifying unit 32 may calculate the value indicating the degree of match, for example, based on the ratio between the area of the surface with the analysis condition set and that of the tentatively determined surface (the sum of the area in the case where the tentatively determined surface is formed of a group of surfaces) or the degree of proximity between the surface with the analysis condition set and the tentatively determined surface. Further, alternatively, the corresponding relationship identifying unit 32 may calculate a value indicating the degree of match for each of such conditions as mentioned above and multiply the calculated values, and then output the multiplication result as the final index for the degree of match.

Note that the corresponding relationship identifying unit 32 may designate, as tentatively determined targets, a plurality of surfaces each associated with a value indicating a different degree of match.

(Tentative Match Determination Process for Solids)

When, in step S22, no solid that matches the solid with the analysis condition set is determined in the post-update design dataset, the corresponding relationship identifying unit 32 tentatively determines a solid for which the analysis condition is to be set, for example, using one of the following three methods.

(Method 1) The corresponding relationship identifying unit 32 designates, as a tentatively determined target, a solid having the highest number of surfaces whose coordinate information individually matches that of each surface of the solid with the analysis condition set. At this time, the corresponding relationship identifying unit 32 may use a tentatively determined surface corresponding to each surface of the solid with the analysis condition set. This scheme is adopted in order to prevent a lot of solids from failing to be tentatively determined. The scheme may also be adopted by Method 2 described below.

(Method 2) Assume that the post-update design dataset includes a plurality of solids each having one or more surfaces whose coordinate information matches that of one or more of a plurality of surfaces of the solid with the analysis condition set, and that the plurality of solids also includes other surfaces that share the same coordinate information. Further, assume that the total volume of a group formed of the plurality of solids coincides with the volume of the solid with the analysis condition set. In this case, the corresponding relationship identifying unit 32 tentatively determines this group as a solid that matches the solid with the analysis condition set.

There may be no group consisting of a plurality of solids, whose total volume exactly coincides with the volume of the solid with the analysis condition set. In that case, the corresponding relationship identifying unit 32 may select, as a tentatively determined target, a group with total volume which most closely matches the volume of the solid with the analysis condition set.

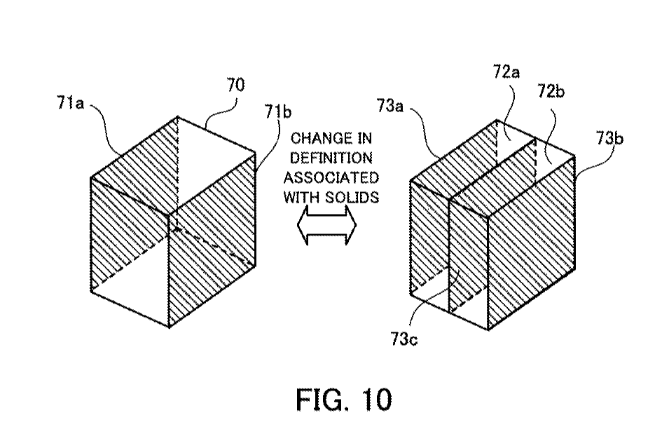

FIG. 10 illustrates an example of Method 2 for tentatively determining a matching solid or solids.

Assume that, in FIG. 10, a solid 70 with surfaces 71a and 71b is defined in a pre-update design dataset. However, a design change of a corresponding object causes a change in the definition of the solid 70, and two solids 72a and 72b are defined in a post-update design dataset, in place of the solid 70. If an analysis condition has been set for the solid 70, the corresponding relationship identifying unit 32 performs a procedure described next.

If having detected the solid 72a having a surface 73a whose coordinate information matches that of the surface 71a and the solid 72b having a surface 73b whose coordinate information matches that of the surface 71b, the corresponding relationship identifying unit 32 judges whether different surfaces on the individual solids 72a and 72b share the same coordinate information. In the example of FIG. 10, a surface 73c is shared by the solids 72a and 72b, and it thus turns out that the different surfaces of the two solids 72a and 72b match each other. In this case, the corresponding relationship identifying unit 32 calculates the sum of the volume of the solids 72a and 72b. If the calculated sum of the volume matches the volume of the solid 70, then the corresponding relationship identifying unit 32 tentatively determines a group consisting of the solids 72a and 72b as a solid for which the analysis condition is to be set.

Thus, this procedure provides an opportunity of setting an analysis condition (to be described later) to the group described above even if a design change of a corresponding object has caused a change in the definition of a solid.

If, by Method 2 above, the total volume of the group is different from the volume of the solid with the analysis condition set, the corresponding relationship identifying unit 32 designates the solid obtained by Method 1 as a tentatively determined target. On the other hand, if, by Method 2, the total volume of the group coincides with the volume of the solid with the analysis condition set, the corresponding relationship identifying unit 32 does not use the solid obtained by Method 1 and designates the group obtained by Method 2 as a tentatively determined target instead.

If a design change of a corresponding object causes a change in the definition associated with solids in such a manner that a plurality of solids, for each of which an analysis condition is set, is changed to a single solid (that is, the change here is caused in an inverse manner to the change described above), the corresponding relationship identifying unit 32 may designate, with respect to each of the plurality of solids, the common single solid as a tentatively determined target.

Assume that, for example, the post-update design dataset includes a single solid having surfaces whose coordinate information individually matches that of a surface included in each of a plurality of solids for which the same analysis condition is set. Assume also that the plurality of solids includes not only these surfaces whose coordinate information individually matches that of each surface on the solid included in the post-update design dataset, but also other surfaces with matching coordinate information. Further, assume that the total volume of a group formed of the plurality of solids (i.e., the sum of the volume of the individual solids) each with the analysis condition set coincides with the volume of the single solid included in the post-update design dataset. In this case, the corresponding relationship identifying unit 32 tentatively determines the single solid in the post-update design dataset as a solid that matches the plurality of solids with the analysis condition set. This procedure is carried out, for example, when the solids 72a and 72b of FIG. 10 are solids with the analysis condition set and the solid 70 is a solid included in the post-update design dataset.

(Method 3) If no solid having surfaces whose coordinate information individually matches that of each surface of the solid with the analysis condition set is found in the post-update design dataset, the corresponding relationship identifying unit 32 executes, for example, the following procedure.

The corresponding relationship identifying unit 32 designates, amongst solids included in the post-update design dataset, a solid whose center of gravity comes closest to the solid with the analysis condition set as a tentatively determined target. Alternatively, the corresponding relationship identifying unit 32 designates, amongst the solids included in the post-update design dataset, a solid having a volume closest to that of the solid with the analysis condition set. Further, alternatively, assuming that surfaces individually lying in the same curved plane as each curved surface defining the solid with the analysis condition set are recognized as matching surfaces, the corresponding relationship identifying unit 32 designates, amongst the solids included in the post-update design dataset, a solid having a highest number of matching surfaces as a tentatively determined target.

The corresponding relationship identifying unit 32 may calculate a value indicating the degree of match between the solid with the analysis condition set and the tentatively determined solid. For example, if the tentatively determined solid has a higher number of surfaces whose coordinate information individually matches that of each surface of the solid with the analysis condition set, the corresponding relationship identifying unit 32 assigns a value indicating a higher degree of match. Alternatively, the corresponding relationship identifying unit 32 may calculate the value indicating the degree of match, for example, based on the ratio between the volume of the solid with the analysis condition set and that of the tentatively determined solid (the sum of the volume in the case where the tentatively determined solid is formed of a group of solids) or how close the center of gravity of the tentatively determined solid (the degree of proximity) to the solid with the analysis condition set. Further, alternatively, the corresponding relationship identifying unit 32 may calculate a value indicating the degree of match for each of such conditions as mentioned above and multiply the calculated values, and then output the multiplication result as the final index for the degree of match.

Note that the corresponding relationship identifying unit 32 may designate, as tentatively determined targets, a plurality of solids each associated with a value indicating a different degree of match.

The corresponding relationship identifying unit stores, in the tentatively determined region storing unit 37, information on one or more regions (points, edges, surfaces, or solids) tentatively determined in the above-described manner, the analysis condition to be set for the regions, and values each indicating the degree of match if the values have been calculated.

(Step S26) After steps S24 and S25, the analysis condition setting unit 31 judges whether, in step S21, all regions for which the analysis condition selected in step S20 is set have been selected from the pre-update design dataset. The process returns to step S21 if any pending region with the analysis condition set remains, and moves to step S27 if all the regions with the analysis condition set have already been selected.

(Step S27) The analysis condition setting unit judges whether, in step S20, all analysis conditions have been selected from the pre-update design dataset. The process returns to step S20 if any pending analysis condition remains, and moves to step S28 if all the analysis conditions have already been selected.

(Step S28) The display unit 34 judges whether there are one or more tentatively determined regions. If there is no tentatively determined region, the corresponding relationship identification process and the analysis condition setting process end. If there are one or more tentatively determined regions, the process moves to step S29.

(Step S29) Based on information about the tentatively determined regions, stored in the tentatively determined region storing unit 37, the display unit 34 causes the display 24a to present a screen for prompting the user to decide whether to set a corresponding analysis condition for each tentatively determined region. If the information about the tentatively determined regions in the tentatively determined region storing unit 37 includes values each indicating the degree of match, the display unit 34 causes the display 24a to also present these values. In addition, the display unit 34 may cause the display 24a to also present regions for which matching regions have been determined and those for which no matching regions have been determined (undetermined regions).

(Step S30) The analysis condition setting unit 31 judges whether the user has instructed, using the input device 25a, to set a corresponding analysis condition for each tentatively determined region. If no instruction for setting analysis conditions for the tentatively determined regions is received from the user, the corresponding relationship identification process and the analysis condition setting process end. On the other hand, the process moves to step S31 if an instruction for setting analysis conditions for the tentatively determined regions is received.

Note that the analysis condition setting unit 31 may also receive, from the user, an instruction to set or change an analysis condition for each undetermined or determined region.

(Step S31) Based on the content of the instruction from the user, the analysis condition setting unit 31 sets a corresponding analysis condition for each tentatively determined region. In addition, if having received, from the user, an instruction to set or change an analysis condition for each undetermined or determined region, the analysis condition setting unit 31 sets or changes the analysis condition based on the content of the received instruction. The analysis condition setting unit 31 stores, in the analysis condition information storing unit 36, information about the analysis condition set or changed in this manner.

After these corresponding relationship identification process and the analysis condition setting process end, the process carried out by the information processor 20 moves to step S18 described above.

Note that the sequence of the processing steps described above is merely an example and the embodiments herein are not limited in this respect.

As described above, the information processor 20 of the second embodiment sets each analysis condition in association with the post-update design dataset based on a corresponding relationship between regions each included in pre-update and post-update design datasets, identified from coordinate information included in the individual pre-update and post-update design datasets. This prevents unintentional analysis conditions from being set in association with the post-update design dataset, which could occur, for example, in associating each analysis condition with a shape ID, thus being able to avoid a structural analysis from yielding erroneous results. In addition, this technique reduces the need of resetting analysis conditions for the post-update design dataset in a reanalysis after a design change.

The information processor 20 also eliminates the need of holding shape IDs, which in turn eliminates the need of allocating memory space for the shape IDs.

In addition, even if the post-update design dataset does not include a region whose coordinate information matches that of a region for which an analysis condition is set, the information processor 20 identifies a region similar to the region with the analysis condition set and thus allows setting of the analysis condition to the identified similar region. At this time, the information processor 20 calculates a value indicating the degree of match between the region with the analysis condition set and the similar region and causes the display 24a to present the value, to thereby facilitate decision making by the user on whether to set the analysis condition for the similar region.

Note that the above-described processing details are implemented by causing the information processor 20 to execute a program, as described above.

Such a program may be recorded in a computer-readable storage medium (for example, the storage medium 26a). Examples of such a computer-readable storage medium include a magnetic disk, an optical disk, a magneto-optical disk, and semiconductor memory. Examples of the magnetic disk are a FD and a HDD. Examples of the optical disk are a compact disc (CD), CD-recordable (CD-R), CD-rewritable (CD-RW), DVD, DVD-R, and DVD-RW. The program may be recorded on portable storage media and then distributed. In such a case, the program may be executed after being copied from such a portable storage medium to a different storage medium (for example, the HDD 23).

According to one aspect, it is possible to prevent a structural analysis from yielding erroneous results.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer program that causes a computer to execute a process comprising:
setting a condition for running a structural analysis simulation of an object, in association with first design data corresponding to the object;
identifying, when the first design data is updated according to a design change of the object, a corresponding relationship between regions each included in the first design data and second design data, which corresponds to the object modified with the design change, based on coordinate information included in the first design data and coordinate information included in the second design data; and
setting, based on the corresponding relationship, the condition in association with the second design data and running the structural analysis simulation of the modified object.

2. The non-transitory computer-readable storage medium according to claim 1, wherein:
when the condition has been set for a first region included in the first design data,
the identifying includes identifying, within the second design data, a second region represented by second coordinate information that matches first coordinate information representing the first region.

3. The non-transitory computer-readable storage medium according to claim 2, wherein the process further includes:
identifying, within the second design data, a third region similar to the first region, based on the first coordinate information when the second design data does not include the second region;
causing a display device to present the third region; and
setting the condition for the third region upon receiving an instruction signal that instructs setting of the condition for the third region.

4. The non-transitory computer-readable storage medium according to claim 3, wherein:
the process further includes calculating, based on the first coordinate information and third coordinate information representing the third region, a value indicating a degree of match between the first region and the third region; and
the causing includes causing the display device to present the value with the third region.

5. The non-transitory computer-readable storage medium according to claim 3, wherein the process further includes:
when the second design data includes a fourth region and a fifth region, the fourth region including a second element represented by fifth coordinate information that matches fourth coordinate information representing a first element included in the first region, the fifth region including a fourth element represented by seventh coordinate information that matches sixth coordinate information representing a third element included in the first region and also including a sixth element represented by ninth coordinate information that matches eighth coordinate information representing a fifth element included in the fourth region,
deciding, based on a result of comparing length or size of a group including the fourth region and the fifth region with length or size of the first region, whether to identify the group as the third region.

6. The non-transitory computer-readable storage medium according to claim 3, wherein the process further includes:
when the condition has been set for a sixth region and a seventh region that are included in the first design data, and
when the second design data includes an eighth region including an eighth element represented by eleventh coordinate information that matches tenth coordinate information representing a seventh element included in the sixth region and also including a tenth element represented by twelfth coordinate information representing a ninth element included in the seventh region, and the seventh region includes a twelfth element represented by fourteenth coordinate information that matches thirteenth coordinate information representing an eleventh element included in the sixth region,
deciding, based on a result of comparing length or size of a group including the sixth region and the seventh region with length or size of the eighth region, whether to identify the eighth region as the third region.

7. The non-transitory computer-readable storage medium according to claim 2, wherein the process further includes:
when, in addition to the second region, a ninth region represented by fifteenth coordinate information that matches the first coordinate information is identified in the second design data,
determining the second region or the ninth region, whichever is included in an eleventh region represented by seventeenth coordinate information that matches sixteenth coordinate information representing a tenth region including the first region, as a region corresponding to the first region.

8. A structural analysis simulation method comprising:
setting, by a processor, a condition for running a structural analysis simulation of an object, in association with first design data corresponding to the object;
identifying, by the processor, when the first design data is updated according to a design change of the object, a corresponding relationship between regions each included in the first design data and second design data, which corresponds to the object modified with the design change, based on coordinate information included in the first design data and coordinate information included in the second design data; and
setting, by the processor, based on the corresponding relationship, the condition in association with the second design data and running the structural analysis simulation of the modified object.

9. An information processing apparatus comprising:
a memory configured to store first design data corresponding to an object; and
a processor configured to execute a process including:
setting a condition for running a structural analysis simulation of the object, in association with the first design data;
identifying, when the first design data is updated according to a design change of the object, a corresponding relationship between regions each included in the first design data and second design data, which corresponds to the object modified with the design change, based on coordinate information included in the first design data and coordinate information included in the second design data; and
setting, based on the corresponding relationship, the condition in association with the second design data and running the structural analysis simulation of the modified object.
